(19) United States
(12) Patent Application Publication
(10) Pub. No.: US 2009/0208119 A1
(43) Pub. Date: Aug. 20, 2009

(54) METHOD FOR GENERATING AND PLAYING IMAGE FILES FOR SLIDESHOWS

(75) Inventors: Gun-Ill LEE, Seoul (KR); Jae-Yeon Song, Seoul (KR); Seo-Young Hwang, Suwon-si (KR)

Correspondence Address: THE FARRELL LAW FIRM, LLP, 290 Broadhollow Road, Suite 210E, Melville, NY, 11747, US

(73) Assignee: SAMSUNG ELECTRONICS CO., LTD., Suwon-si (KR)

(21) Appl. No.: 12/372,324

(22) Filed: Feb. 17, 2009

(30) Foreign Application Priority Data
Feb. 15, 2008 (KR) 10-2008-0014161

(51) Int. Cl. G06K 9/36

(52) U.S. Cl. 382/232

(57) ABSTRACT

A system for generating and playing image files for slideshows is provided. The system includes an image file generator that generates image files. Each image file has an image track including at least two images for slideshow images and information for the slideshow images enabling at least two images to be sequentially displayed at specified time intervals. The system also includes an image file player that extracts the information for the slideshow images from the image files inputted from the image file generator, and provides the at least two images of the image track for a slideshow service.

### PRIORITY

This application claims priority under 35 U.S.C. §119(a) to an application entitled “System And Method For Generating And Playing Image Files For Slideshows” filed in the Korean Intellectual Property Office on Feb. 15, 2008 and assigned Serial No. 10-2008-0014161, the contents of which are incorporated herein by reference.

### BACKGROUND OF THE INVENTION 1. Field of the Invention

The present invention relates generally to a method for generating and playing image files for slideshows, and more particularly to a file format for generating and playing image files for slideshows, and a method using the file format.

2. Description of the Related Art

Presently, Moving Picture Experts Group (MPEG), which is the multimedia-related International Organization for Standardization, has been progressing with the standardization of MPEG-2, MPEG-4, MPEG-7, and MPEG-21. With the development of these standards, there has been an increased need for one profile that combines the different standard techniques. MPEG Application: ISO/ICE 230000 (MPEG-A) multimedia application standardization activity is one such profile. The MPEG-A activity prepares diverse Multimedia Application Formats (MAF), and the purpose of which is to maximize the use value of the standards by combining not only the existing MPEG standards but also the non-MPEG standards. By easily combining the standard techniques, having already been verified, without any effort to make separate new standards, the multimedia application formats can be made to maximize their use values.

A service that brings terminal service providers great gains is a star picture album service. Using this service, a user can download still image JPG files through his/her terminal, and see desired still images on the terminal. However, the user downloads the image files one by one.

Recently, with the launching of stereoscopic terminals, users can enjoy three-dimensional (3D) images such as the star picture album through the stereoscopic terminals. The Working Draft (WD) document of the Stereoscopic MAF International Organization for Standardization (ISO/IEC 23000-11) places the focus on a moving image stereoscopic content service.

### SUMMARY OF THE INVENTION

The present invention has been made to address at least the above-mentioned problems and/or disadvantages and to provide at least the advantages described below. Accordingly, an aspect of the present invention provides a file format required to generate, store, and play image files for slideshows. Another aspect of the present invention provides a system and a method for generating and playing image files using a file format of image files for slideshows.

According to one aspect of the present invention, a system is provided for generating and playing image files for slideshows. An image file generator generates image files. Each image file has an image track including at least two images for slideshow images and information for the slideshow images enabling the at least two images to be sequentially displayed at specified time intervals. An image file player extracts the information for the slideshow images from the image files inputted from the image file generator, and provides the at least two images of the image track for a slideshow service.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a diagram illustrating the structure of a storage format of a 2D image file according to the conventional standard technology;

FIG. 2 is a diagram illustrating the structure of a storage format of an image file according to an embodiment of the present invention;

FIG. 3A is a diagram illustrating the structure of a storage format of an image file according to another embodiment of the present invention;

FIG. 3B is a diagram illustrating an example of the storage format of the image file as illustrated in FIG. 3A;

FIG. 4A is a diagram illustrating the structure of a storage format of an image file according to a further embodiment of the present invention;

FIG. 4B is a diagram illustrating an example of the storage format of the image file as illustrated in FIG. 4A;

FIG. 5 is a block diagram illustrating the configuration of an image file generator according to an embodiment of the present invention;

FIG. 6 is a block diagram illustrating the configuration of an image file player according to an embodiment of the present invention; and

FIG. 7 is a flowchart illustrating a method for playing image files according to an embodiment of the present invention.

### DETAILED DESCRIPTION OF THE PREFERRED EMBODIMENTS

Preferred embodiments of the present invention are described in detail with reference to the accompanying drawings. In the following description, the same or similar elements are designated by the same or similar reference numerals although they are shown in different drawings. Detailed descriptions of constructions or processes known in the art may be omitted to avoid obscuring the subject matter of the present invention.

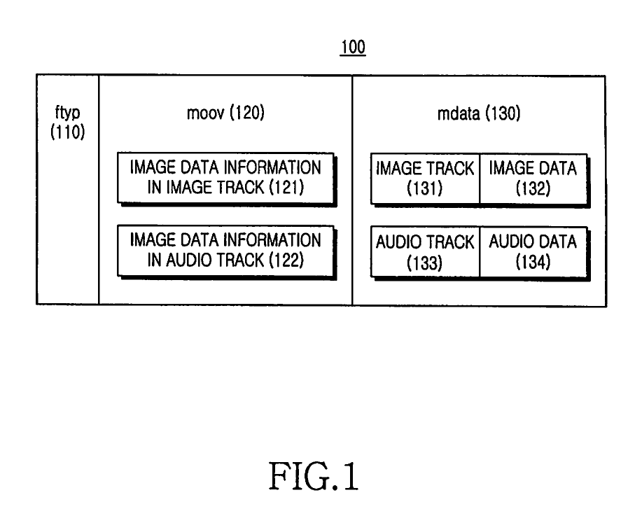

A format of image files for a two-dimensional (2D) image according to the conventional standard technology is described below with reference to FIG. 1. FIG. 1 shows a format 100 of a 2D image file according to the conventional ISO 14496-12.

The 2D image file format 100 is composed of a File type (Ftyp) region 110 that corresponds to the uppermost level, a Movie data (Moov) region 120, and a Media data (Mdata) region 130. The media data region 130 is a data region. Actual image data is included in an image track 131, and audio data is included in an audio track 133. In the respective tracks, the image data and the audio data are stored in the unit of a frame. The Moov region 120 corresponds to a header region in the file format, and has an object-based structure. The Moov region includes content information, such as frame rate, bit rate, image size, and the like, and all the information for a file play, such as synchronization information for supporting a playback function such as FF/REW, and the like. In particular, the Moov region includes information such as the total number of frames of image data and audio data, the size of each frame, and the like, and thus the image data and the audio data can be restored and played by parsing the Moov region 120 during a playback operation.

The embodiments of the present invention implement a storage format of an image file including slideshow images by changing the storage format of the image file of the 2D image in FIG. 1, and implement a system composed of an image file generator and an image file player using this format.

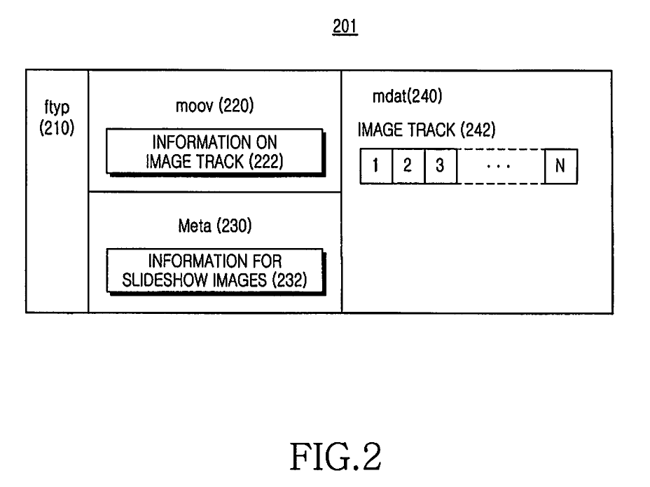

Hereinafter, with reference to FIG. 2, a storage format of an image file including slideshow images according to an embodiment of the present invention will be described in detail.

As described above, according to an embodiment of the present invention, the format of an image file 201 including slideshow images is implemented by adding a box 232 containing information on the image file including the slideshow images, to the format 100 of the 2D image file as illustrated in FIG. 1. Accordingly, the structure and the function of the existing 2D image file format can be used as they are.

First, the slideshow is defined as a service for displaying two or more items at specified time intervals. Here, the items constituting the slideshow means display contents being displayed for a time period when the slideshow is executed. That is, the slideshow is defined to display items for a time period. Accordingly, the items constituting the slideshow may be constructed as one 2D image, or may be constructed as a 3D image composed of two or more images. Also, the slideshow may be constructed as a moving image being displayed for a short period such as a flash.

Accordingly, the information on the slideshow images includes information on which item among the items constituting the slideshow the respective image frames of the image track correspond to, and information on the time interval between the items. According to the embodiments of the present invention, the information on the slideshow images is not limited to the above-described information, and may include any information that can be analogized by a person of ordinary skill in the art to execute the slideshow.

In the embodiment of the present invention of FIG. 2, a meta data region 230, in which the box 232 including the information for the slideshow images can be positioned, is added to the format 100 of the image file of FIG. 1. Accordingly, the box 232 including the information for the slideshow images is included in the metadata region 230. The box 232 including the information for the slideshow images includes information required to play the slideshow images, i.e. an image stream, included in an image track 242. That is, in the case where the player plays an image file including slideshow images, i.e. including two or more images, the information for the slideshow images enables the player to confirm the position and size of the respective images and display the respective images in order.

A format of an image file according to an embodiment of the present invention is described with reference to FIG. 2. FIG. 2 illustrates a storage format of an image file in the case where the image file for the slideshow is composed of one image stream. The storage format 201 of the image file includes a file type region 210 of the uppermost level, a Moov region 220 belonging to a header region, a media data region 240 that is a data region, and the metadata region 230.

Here, the media data region 240 includes the image track 242, and may include an audio track (not illustrated). Image data is stored in the image track 242. More specifically, in the image track 242, at least two images or image frames for a slideshow service are encoded and stored. In this case, the image track 242 may include image data for constituting the 2D image, or first image data and second image data for constituting the 3D image.

If the image data constitutes the 3D image, the image track 242 may include, for example, left-viewpoint image data and right-viewpoint image data to constitute one 3D image. In this case, the player can construct and display one 3D image using the left-viewpoint image data and the right-viewpoint image data of the image track 242.

The Moov region 220 includes a box 222 including information on the image track. The box 222 including the information on the image track 242 has information on the position and size of each image frame included in the image track 242.

The metadata region 230 includes the box 232 including information for slideshow images. The box 232 including the information for the slideshow images includes information on relations between image frames included in the image track 242 and one or more items constituting the slideshow.

In another embodiment of the present invention, the media data region 240 may include an image track for the left-viewpoint image data and an image track for the right-viewpoint image data for the 3D image. If the media data region 240 includes the audio track, the audio data included in the audio track may be synchronized with the image data to be played.

The Moov region 220 corresponds to the header region of the file format, and if information 222 on the image track and an audio track exists, it includes information on the audio track. The information 222 on the image track includes content information, such as frame rate, bit rate, image size, and the like, and general information for file play, such as synchronization information for supporting a playback function such as FF/REW. In particular, the Moov region 220 includes information, such as the total number of image frames in the image track 242, the size of each frame, and the like. During a playback operation, the information on the image data is acquired through parsing of the Moov region 220.

In the embodiment of the present invention, the metadata region 230, in which the box 232 including the information for the slideshow images is included, exists in the storage format 201 of the image file. In the embodiment of the present invention, the metadata region 230 is implemented in the same level as the Moov region 220 or the media data region 240. The box 232 including the information for the slideshow images includes information on the position and size of items for the slideshows.

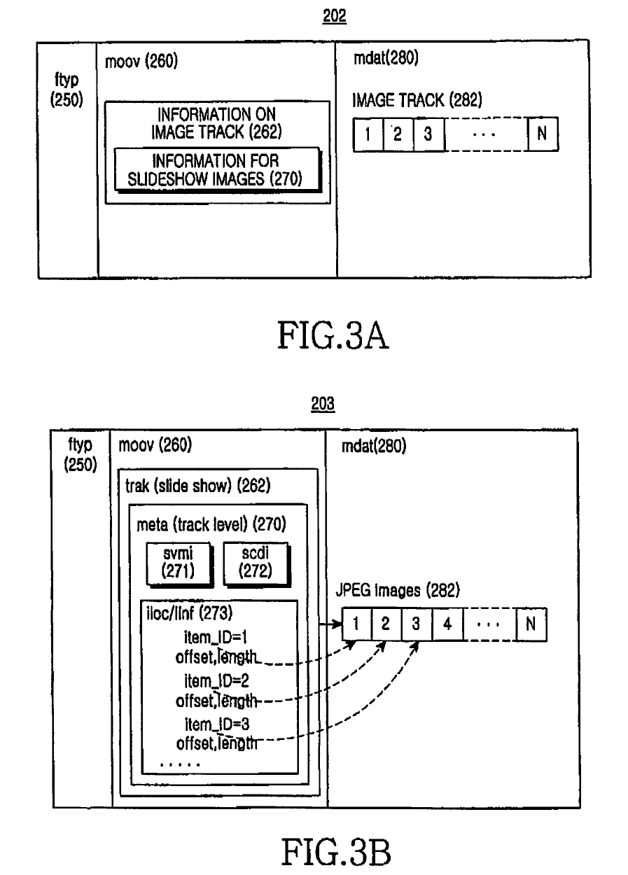

A format of an image file according to another embodiment of the present invention will be described with reference to FIG. 3A. FIG. 3A illustrates a storage format of an image file according to another embodiment of the present invention. According to the storage format of FIG. 3A, unlike the storage format of FIG. 2A, a box including the information for the slideshow images is included in a box 262 including information on the image track.

A storage format 202 of the image file according to this embodiment of the present invention also includes a file type region 250 of the uppermost level, a media data region 280 that is a data region, and a Moov region 260 that is a header region. Since the file type region 250 and the media data region 280 are the same as those in the embodiment of the present invention as illustrated in FIG. 2, the detailed description thereof will be omitted.

In the embodiment of the present invention illustrated in FIG. 3A, the Moov region 260 corresponds to the header region of the file format, and includes the information 262 on the image track. Also, the Moov region 260 includes information 270 for the slideshow images related to the corresponding image track.

FIG. 3B is a view illustrating an example of the storage format of the image file as illustrated in FIG. 3A.

As illustrated in FIG. 3B, a storage format 203 of the image file includes a file type region 250, a Moov region 260, and a media data region 280.

The Moov region 260 includes track box 262 including information on the image track. The track box 262 includes box 270 which stores information on the corresponding image track and includes information for the slideshow images. In FIG. 3B, the box 270 including the information for the slideshow images is implemented as a meta box in the track level. The meta box 270 may include an svmi box 271, an scdi box 272, an iloc box and/or an iinf box 273. The svmi box 271 is a box for stereoscopic video media information, and the scdi box 272 is a box for stereoscopic camera and display safety information. The iloc box is a box designated for item location, and the iinf box is a box designated for item information. The definition, syntax, and semantics of the svmi box 271 are as shown in Table 1 below.

```
TABLE 1
[Definition]
Box Type:  ‘svmi’
Container:  Meta Box(‘meta’) or Sample Table Box (‘stbl’)
Mandatory:  Yes
Quantity:  Exactly one
[Syntax]
aligned(8) class StereoscopicVideoMediaInformationBox extends
FullBox(‘svmi’, version = 0, 0){
// stereoscopic visual type information
unsigned int(8)  stereoscopic_composition_type;
unsigned int(1)  is_left_first;
unsigned int(7)  reserved;
// stereo_mono_change information
unsigned int(32) stereo_mono_change_count;
for(i=0; i<stereo_mono_change_count; i++){
  unsigned int(32) sample_count;
  unsigned int(1) stereo_flag;
  unsigned int(7) reserved;
}
}
[Semantics]
stereoscopic_composition_type:  frame construction type of stereoscopic
video content (0: side-by-side, 1: vertical line interleaved, 2: frame
sequential, 3: monoscopic left image, 4: monoscopic right image)
is_left_first:  indicates which one of left image and right image is first
encoded
stereo_mono_change_count: the number of fragments when frame is
changed from stereo to mono, or from mono to stereo
sample_count:  the number of samples (frames) having successive values
stereo_flag:  indicates whether current frame is of stereo or mono (0:
mono, 1: stereo)
```

Specifically, the svmi box is a box for storing stereo/mono information on respective samples of the Elementary Stream (ES) included in the image track. In FIG. 3B, a container including the svmi box is a meta box. However, the container including the svmi box may also be an stbl box. The container is an upper box including the current box. In this embodiment of the present invention, the meta box has been proposed as the container of the svmi box. However, the present invention is not limited thereto, and the container of the svmi box may be freely moved to a position “table of boxes” on more suitable ISO/IEC 14496-12 ISO base media file formats.

The definition, syntax, and semantics of the scdi box 272 are as shown in Table 2 below.

```
TABLE 2
[Definition]
Box Type:  ‘scdi’
Container:  Meta Box(‘meta’)
Mandatory:  No
Quantity:  Zero or One
[Syntax]
aligned(8) class StereoscopicCameraAndDisplayInformationBox extends
  FullBox(‘scdi’, version = 0, 0){
unsigned int (16) item_count;
for( i=0; i<item_count; i++ ){
  unsigned int(16) item_ID;
  unsigned int(1)  is_item_ID_ref;
  unsigned int(7)  reserved;
  if(is_item_ID_ref){
    unsigned int(16) ref_item_ID;
  }
  else{
    // stereoscopic display information
    unsigned int(1) is_display_safety_info;
    unsigned int(7) reserved;
    if(is_display_safety_info) {
      unsigned int(16) expected_display_width;
      unsigned int(16)  expected_display_height;
      unsigned int(16)  expected_viewing_distance;
      int(16)  min_of_disparity;
      int(16)  max_of_disparit;
    }
    // stereoscopic camera information
    unsigned int(1) is_cam_params;
    unsigned int(7) reserved;
    if(is_cam_params){
      unsigned int(32)  baseline;
      unsigned int(32)  focal_length;
      unsigned int(32) convergence_distance;
      unsigned int(1)  is_camera_cross;
      unsigned int(7)  reserved;
      if (is_camera_cross){
        unsigned int(32) rotation;
      }
    }
  }
  }
}
[Semantics]
item_count: the number of stereoscopic fragments
item_ID: ID for pointedly calling the stereoscopic fragment
is_item_ID_ref: indicates whether to use a parameter of another item
ref_item_ID: stereoscopic fragment ID including the parameter used as the reference
is_display_safety_info:  indicates whether to include safety information of stereoscopic
display
expected_display_width: optimum display width (mm)
expected_display_height: optimum display height (mm)
expected_viewing_distance: optimum viewing distance (mm)
min_of_disparity:  minimum disparity between left image and right image
max_of_disparity:  maximum disparity between left image and right image
is_cam_params: indicates whether to include camera parameter information
baseline: distance between two cameras
focal_length:  distance from the optical center to an image plane
convergence_distance:  distance from the center of baseline to the convergence point
is_camera_cross:  defines camera arrangement (0: parallel arrangement, 1: cross
arrangement)
rotation:  camera position angle toward an object
```

The iloc box is a box designated for item location. The iinf box is a box designated for item information. The iloc/iinf box 273 includes information on the position of an image frame and the size or length of the image frame corresponding to each item constituting the slideshow. As illustrated in FIG. 3B, “item_ID=1” corresponds to block 1 in an image frame 282, “item_ID=2” corresponds to block 2 in the image frame 282, and “item_ID=3” corresponds to block 3 in the image frame 282. The player can provide a slideshow service to users by displaying images of the image frame with reference to such item-related information.

When the image file includes both a track including a moving image and a track including a still image, such tracks cannot be identified. The embodiments of the present invention use the iloc/iinf box to solve this problem. For example, the content_type syntax value of the iinf box is used, and this value has a Multi-purpose Internet Mail Extension (MIME) type value. For example, in the case of an MPEG-4 moving image, the content type is expressed as ‘content_type=video/mpr’, while in the case of a JPEG image, the content type is expressed as ‘content_type=image/jpg’.

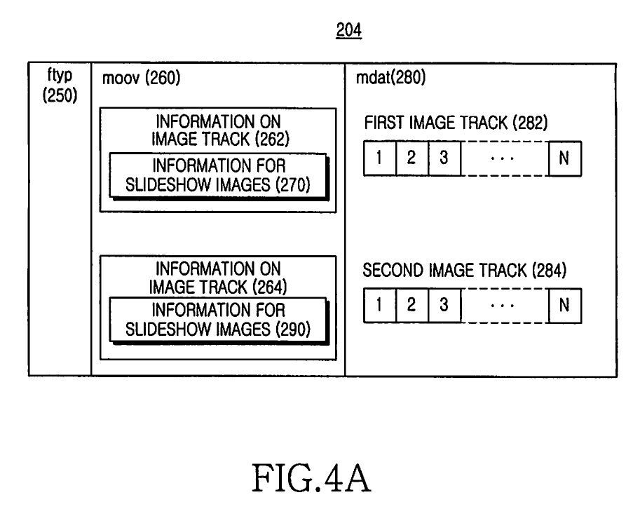

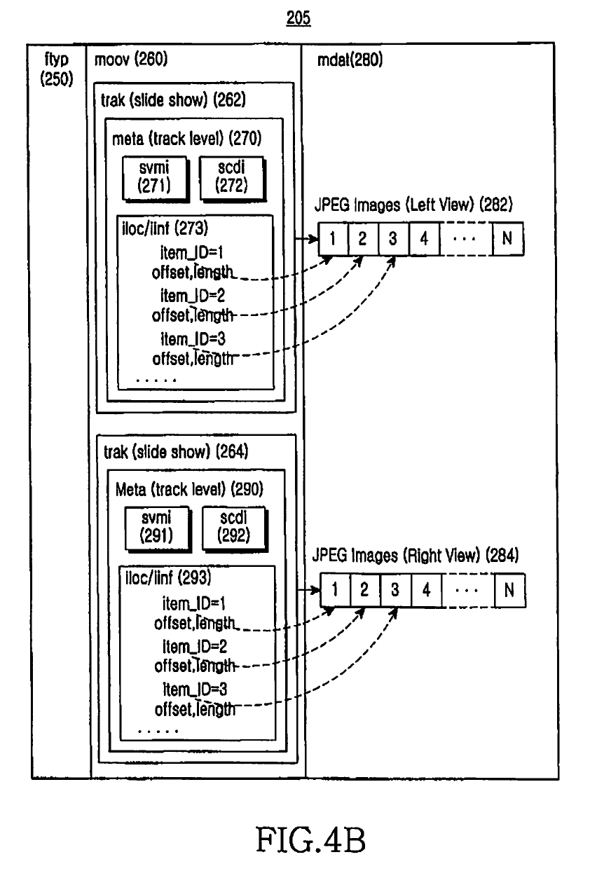

FIG. 4A illustrates a storage format of an image file according to another embodiment of the present invention. According to the storage format of FIG. 4A, unlike the storage format of FIG. 3A, two image tracks, rather than one image track, are included in the storage format.

A storage format 204 of the image file according to this embodiment of the present invention also includes the file type region 250 of the uppermost level, the media data region 280 that is a data region, and the Moov region 260 that is a header region.

The media data region 280 includes the first image track 282 and a second image track 284, and the Moov region 260 includes the box 262 including information on the first image track 282 and a box 264 including information on the second image track 284. Also, the box 262 including the information on the first image track 282 and the box 264 including the information on the second image track 284 include information 270 and 290 for the slideshow images related to the corresponding image tracks, respectively.

FIG. 4B is a view illustrating an example of the storage format of the image file as illustrated in FIG. 4A.

As illustrated in FIG. 4B, the storage format 205 of the image file includes the file type region 250, the Moov region 260, and the media data region 280.

The Moov region 260 includes track box 262 including information on the first image track, and track box 264 including information on the second image track. The track boxes 262 and 264 include boxes 270 and 290 which store information on the corresponding image tracks and include information for the slideshow images, respectively.

In FIG. 4B, the boxes 270 and 290 including the information for the slideshow images are implemented as meta boxes in the track level. The meta box 270 or 290 may include an svmi box 271 or 291, an scdi box 272 or 292, and an iloc box and/or an iinf box 273 or 293. The features of the svmi box, the scdi box, the iloc box, and the iinf box have been described with reference to FIG. 3B.

In FIGS. 3B and 4B, the image included in the image track is a JPEG image. However, the image that can enter into the elementary stream (ES) of the media data (Mdat) region may be of any type, such as JPEG, PNG, BMP, TIFF<JPEG2000, MPEG I-frame, GIF, animation GIF, PGMYUV, PGM, YUV, SGI, and the like.

Table 3 shows an example of a “table for boxes” required for a slideshow service of a stereoscopic image. This is the same as a “table for boxes” of a file format for a moving image stereoscopic content service in the Stereoscopic MAF International Standardization. This table includes existing boxes defined in the ISO/IEC 14496-12 ISO base media file format document and boxes newly added for the stereoscopic content according to the present invention.

TABLE 3

| | | | | | | |
|---|---|---|---|---|---|---|
| ftyp | | | | | | file type and compatibility |
| pdin | | | | | | Progressive download Information |
| moov | | | | | | container for all the metadata |
| | mvhd | | | | | movie header, overall declarations |
| | trak | | | | | container for an individual track or stream |
| | | tkhd | | | | track header, overall information about the track |
| | | tref | | | | track reference container |
| | | edts | | | | edit list container |
| | | | elst | | | an edit list |
| | | mdia | | | | container for the media information in a track |
| | | | mdhd | | | media header, overall information about the media |
| | | | hdlr | | | handler, declares the media (handler) type |
| | | | minf | | | media information container |
| | | | | vmhd | | video media header, overall information (video track only) |
| | | | | smhd | | sound media header, overall information(sound track |
| | | | | | | only) |
| | | | | hmhd | | hint media header, overall information (hint track only) |
| | | | | nmhd | | Null media header, overall information (some tracks only) |
| | | | | dinf | | data information box, container |
| | | | | | dref | data reference box, declares soure(s) of media data in |
| | | | | | | track |
| | | | | stbl | | sample table box, container for the time/space map |
| | | | | | stsd | sample descriptions (codec types, initialization etc.) |
| | | | | | stts | (decoding) time-to-sample |
| | | | | | stsc | sample-to-chunk, partial data-offset information |
| | | | | | stsz | sample sizes (framing) |
| | | | | | stz2 | compact sample sizes (framing) |
| | | | | | stco | chunk offset, partial data-offset information |
| | | | | | co64 | 64-bit chunk offset |
| | | | | | stss | sync sample table (random access point) |
| | ipmc | | | | | IPMP Control Box |
| mdat | | | | | | media data container |
| meta | | | | | | metadata |
| | hdlr | | | | | handler, declares the metadata (handler) type |
| | iloc | | | | | item location |
| | iinf | | | | | item information |
| | xml | | | | | XML container |
| | bxml | | | | | binary XML container |
| | scdi | | | | | stereoscopic camera and display information |
| | svmi | | | | | stereoscopic video media information |

By setting “handler type” of the “hdlr” box that is under the “mdia” box to “vide”, an image track for supporting the stereoscopic slideshow content is managed as a video track. Also, the file generator stores indexing and additional information using the “iloc/iinf” box of the “meta” box so that the file player can access image streams sheet by sheet in the ES existing in the “mdat” region.

The player finds out the decoding time, start address and size of each stream using the “stts”, “stsz”, “stsc”, and “stco” boxes in the “stbl” box, and decodes the image using such information to finally display the image on the LCD.

In the above-described embodiments of the present invention, the box including the information for the slideshow images, as illustrated in FIGS. 3B and 4B, is included in the metadata region in the track level. However, it is apparent to a person of ordinary skill in the art that the box including the information for the slideshow images can be in any position in diverse levels according to the implementations in the stereoscopic file format. Accordingly, the position of the box including the information for the slideshow images is not limited to the specified “table for boxes” of the file format.

As described above, the image file having the file format for the slideshow images is constructed to have a value that indicates the image file for the slideshow images. For example, values of compatible brands prescribed in the file (ftyp) box may be used. If values of compatible brands prescribed in the file (ftyp) box are prescribed to indicate the “ss01” type and the “ss02” type, the present invention newly prescribes a “ss03” value to indicate that the slideshow service is supported, which is shown in Table 4 below.

TABLE 4

| Type | Remarks |
|---|---|
| SS01 | Stereoscopic content without partial monoscopic data |
| SS02 | Stereoscopic content with partial monoscopic data |
| SS03 | Stereoscopic slideshow content |

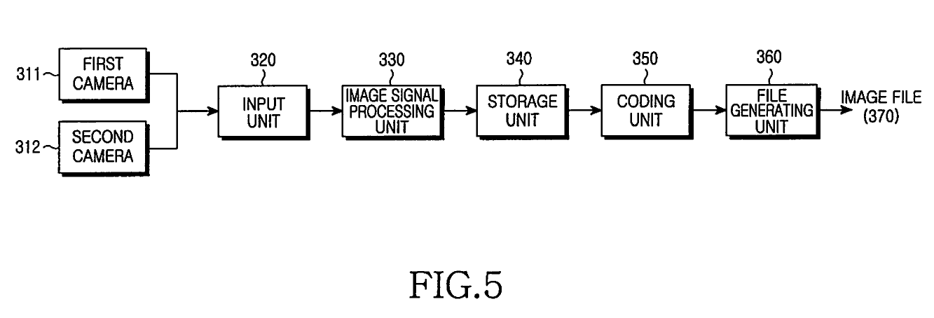

Next, a system for generating and playing image files using the storage formats 201 to 205 of the image files as illustrated in FIGS. 2 to 4B will be described. This system may be composed of an image file generator and an image file player. First, an image file generator according to an embodiment of the present invention is described with reference to FIG. 5.

The image file generator includes a first camera 311, a second camera 312, an input unit 320, an image signal processing unit 330, a storage unit 340, a coding unit 350, and a file generating unit 360.

The first camera 311 outputs first image data by taking a picture of a specified object from the left viewpoint or right view point, and the second camera 312 outputs second image data by taking a picture of the object from a viewpoint different from that of the first camera 311. The first image data and the second image data are input into the image signal processing unit 330 through the input unit 320.

The first image data and the second image data are preprocessed by the image signal processing unit 330. Here, the preprocessing operation is to convert an analog value of an external image, i.e. light and color components of the external image, which has been recognized through a Complementary Metal-Oxide Semiconductor (CMOS) type sensor, into a digital value.

The storage unit 340 stores the first image data and the second image data preprocessed by the image signal processing unit 330, and provides the stored first and second image data to the coding unit 350. In FIG. 5, the storage unit 340 is illustrated, but the detailed construction of the storage unit for buffering between the respective constituent elements as illustrated in FIG. 3 is not separately illustrated. The coding unit 350 encodes the first image data and the second image data provided from the storage unit 340. The encoding operation of the coding unit 350 relates to the encoding of data, and may be omitted as needed.

The file generating unit 360 generates an image file 370 using the first image data and the second image data encoded by the coding unit 350. The file generating unit 360 may generate image files having a file format according to the embodiments of the present invention. The image file for the slideshow of a 2D image includes one of the first image data and a second image data, while the image file for the slideshow of a 3D image includes both the first image data and the second image data.

In addition, the file generating unit 360 adds information on the slideshow images to the image file so that the player can provide the slideshow service using the image files. The image file 370 generated as above is input or transmitted to a stereoscopic image file player, and the image file player plays and displays the slideshow images from the image file 370.

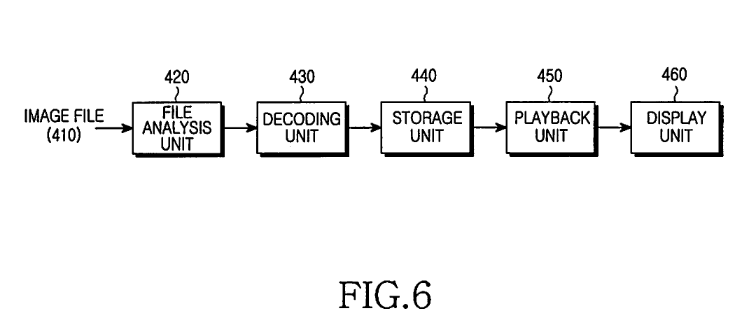

FIG. 6 is a block diagram illustrating the configuration of an image file player according to an embodiment of the present invention. Referring to FIG. 6, the image file player includes a file analysis unit 420, a decoding unit 430, a storage unit 440, a playback unit 450, and a display unit 460.

The file analysis unit 420 receives and analyzes an image file 410 generated by the file generating unit 360 of the image file generator. The file analysis unit 420 analyzes information stored in the Moov regions and the metadata region, and extracts the first image data and/or second image data stored in the media data region.

The decoding unit 430 decodes the extracted first image data and/or second image data. This decoding operation corresponds to the encoding operation performed by the coding unit 350. The decoded data is stored in the storage unit 440.

The playback unit 450 plays the first image data and/or second image data stored in the storage unit 440 as slideshow images.

The display unit 460 displays a 2D image and a 3D image. For this, the display unit 460 is constructed to implement a barrier Liquid Crystal Display (LCD). When displaying a 2D image, the player turns off the barrier LCD, while when displaying a 3D image, it turns on the barrier LCD.

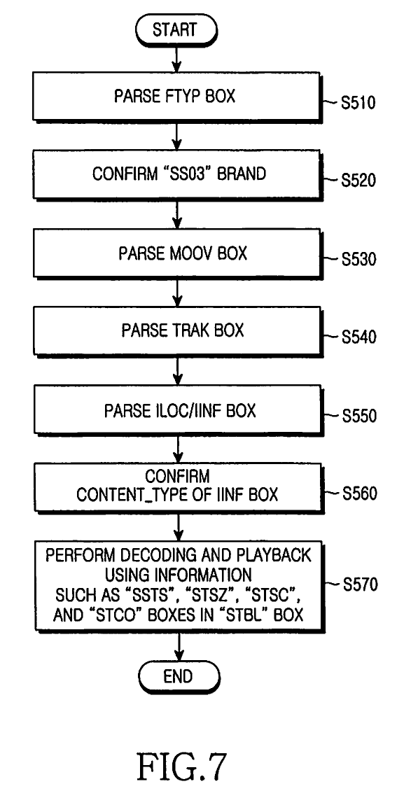

FIG. 7 is a flowchart illustrating a method for playing image files according to an embodiment of the present invention. In FIG. 7, it is exemplified that the player plays the image file as illustrated in FIG. 3B or 4B.

First, referring to FIG. 7, the player parses a file type (ftyp) box from an image file in step S510. The file type (ftyp) box is basically provided from the conventional ISO/IEC q4496-12. The player, for example, confirms the “ss03” brand of compatible brand of the file type (ftyp) box. If the compatible brand of the file type (ftyp) box has an “ss03” type value in step S520, the player judges that the corresponding file has an image format for the slideshows.

Then, the player parses the moov box and a track (trak) box of the image file in steps S530 and S540. Information for the slideshow images is included in the track box of the moov box as illustrated in FIG. 3B or FIG. 4B. The player acquires information for the slideshow images by parsing the moov box and the track box.

The player extracts the iloc/iinf box in the track box, parses the iloc/iinf box in step S550, and confirms the content_type of the iinf box in step S560.

If multiple moving image tracks and still image tracks exist, the content_type of the iinf box is to identify such tracks. Accordingly, the player can play the stereoscopic still image slideshow content by selecting the still image track for the slideshow images using the value of the content_type even if the multiple moving image tracks and image tracks exist.

In step S570, the player can obtain the decoding time, frame size, and start address values of respective images using information of “stts”, “stsz”, “stsc”, and “stco” boxes in the “stbl” box, and decode and play the images using such information.

In explaining the operation of terminals, the file format analysis and the operation of the terminals, which have not been described in detail, will follow the ISO/IEC 14496-12 and ISO/IEC 23000-11.

As described above, according to the present invention, a file format structure that can support the stereoscopic slideshow service can be defined, and can be used as the specification for creating new services of terminal service providers.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for generating image files for a slideshow in a device for generating and playing the image files, comprising the steps of:
generating File type (Ftyp) region defining a type of the image files;
generating Media data (mdat) region including image track having at least two 3D images consisting of left-viewpoint image and right-viewpoint image;
generating Movie data (moov) region having information for the image track; and
generating metadata(meta) region having information for the slideshow.

2. A method for generating image files for a slideshow in a device for generating and playing the image files, comprising the steps of:
generating File type region defined by a type of the image files;
generating Media data region including image track having at least two 3D images consisting of left-viewpoint image and right-viewpoint image; and
generating Movie data region having information for the image track and information for the slideshow.

3. A method for generating image files for a slideshow in a device for generating and playing the image files, comprising the steps of:
generating File type region defining a type of the image files;
generating Media data region including a first image track consisting of at least two left-viewpoint images and a second image track consisting of at least two right-viewpoint images; and
generating Movie data region having information for the image track and information for the slideshow.

4. A method for generating information for a slideshow, comprising the steps of:
generating Movie data region including track box having image track consisting of at least two 3D images; and
generating metadata region having information for the image track and information for the slideshow within the track box.

5. The method of claim 4, wherein the information for the image track including stereoscopic video media information and stereoscopic camera and display safety information.

6. The method of claim 4, wherein the information for the slideshow including information on a position of an image frame and a size or length of the image frame consisting of the slideshow.
